(19) United States
(12) Patent Application Publication
(10) Pub. No.: US 2024/0193419 A1
(43) Pub. Date: Jun. 13, 2024

(54) MULTI-VIEW HYPERBOLIC-HYPERBOLIC GRAPH REPRESENTATION LEARNING METHOD

(71) Applicant: Shanxi University, Taiyuan City (CN)

(72) Inventors: Jianqing LIANG, Taiyuan City, Shanxi (CN); Zhixin ZHANG, Taiyuan City, Shanxi (CN); Jiye LIANG, Taiyuan City, Shanxi (CN)

(21) Appl. No.: 18/534,295

(22) Filed: Dec. 8, 2023

(30) Foreign Application Priority Data
Dec. 11, 2022 (CN) 202211602476.3

(51) Int. Cl. G06N 3/08; G06N 3/0464

(52) U.S. Cl. CPC G06N 3/08; G06N 3/0464

(57) ABSTRACT

The present disclosure belongs to application in the field of deep learning and graph neural networks, and particularly relates to a multi-view hyperbolic-hyperbolic graph representation learning method. Two views are constructed based on a topological relation of nodes and node attributes, then an adjacency matrix and the two views generated are input into a hyperbolic-hyperbolic graph neural network to obtain node representations of three views, graph embedding representations of different views are obtained by performing hyperbolic-hyperbolic convolution and pooling on the node representations of the three views, the graph embedding representations are concatenated and input into a Lorentz multilayer perceptron (MLP) layer to obtain attention scores of the views, and with a hyperbolic-hyperbolic weighted representation, a multi-view based node embedding representation is obtained.

### CROSS REFERENCE TO RELATED APPLICATION

This patent application claims the benefit and priority of Chinese Patent Application No. 202211602476.3 filed with the China National Intellectual Property Administration on Dec. 11, 2022, the disclosure of which is incorporated by reference herein in its entirety as part of the present application.

### BACKGROUND

### Technical Field

The present disclosure belongs to application in the field of deep learning and graph neural networks, and particularly relates to a multi-view hyperbolic-hyperbolic graph representation learning method.

### Background Information

A graph neural network processes graph data through deep learning, and is widely used in natural language processing, recommendation systems, biomedical treatment, etc. Although existing study on the graph neural network has achieved good results, graph information is learnt only through single-view information in most cases. For a given downstream task, topology of an underlying graph is unknown beforehand, and describing a relation between nodes only with a single view inevitably results in information loss to some extent. Thus, how to use multi-view information to learn an effective representation of the node is to be studied.

Existing study on multi-view graph representation learning is limited to an Euclidean space. An existing hyperbolic graph neural network excessively relies on a tangent space for neighborhood aggregation. However, the tangent space only locally approximates points in the hyperbolic space, and does not strictly follow mathematical meaning of hyperbolic geometry. As a result, a graph structure and properties in the hyperbolic space cannot be well preserved. A number of graphs in real world, such as protein interaction networks and social networks, tend to exhibit scale-free or hierarchical structures. Embedding such graphs into the Euclidean space results in distortion to a large extent, and thus it is difficult to express hierarchical information of networks. In contrast, the hyperbolic geometry has natural advantages in capturing this hierarchical structure. Therefore, constructing a graph convolution neural network under a multi-view structure is proposed.

### SUMMARY

In view of the above problem, the present disclosure provides a multi-view hyperbolic-hyperbolic graph representation learning method, which solves a problem of high distortion caused by the Euclidean space, and learns multi-view information. A main objective of the present disclosure is to fully explore graph information of different views and learn a more accurate node representation using a multi-view structure; completely establish basic operations of a graph in the hyperbolic space by using a hyperbolic-hyperbolic graph neural network based on characteristics of a hyperbolic structure, and transmit information in a form of low distortion to obtain a better node representation for node classification and link prediction tasks.

The present disclosure is implemented by the following technical solutions.

A multi-view hyperbolic-hyperbolic graph representation learning method is provided, which includes:
step 1, constructing multiple views from a topological structure and node features of a graph, which includes:
constructing the views from the topological structure of the graph, which specifically includes:
constructing a global topological matrix S^{PPR} by an adjacency matrix of the graph and a limit closed-form solution of a personal pagerank algorithm:

$${S}^{PPR} = {α ( {I}_{n} - ( 1 - α ) {D}^{- \frac{1}{2}} {AD}^{- \frac{1}{2}} )}^{- 1}$$

where D is a degree matrix of the graph, A is the adjacency matrix of the graph, α is a parameter, and Iₙ is a n-order identity matrix; and
constructing the views from the node features of the graph based on a cosine similarity, which specifically includes:
calculating a similarity s_{i,j} between node i and node j by a node feature matrix X, and constructing a connecting edge between node i and node j in the view with a similarity greater than a threshold θ:

$${s}_{i , j} = Similarity ( {x}_{i} , {x}_{j} ) = \frac{{x}_{i} \cdot {x}_{j}}{‖ {x}_{i} ‖ ‖ {x}_{j} ‖}$$

where xᵢ and xⱼ are eigenvectors of the node i and the node j respectively; and
step 2, performing a hyperbolic-hyperbolic graph convolution and pooling on a multi-view structure and the node features so as to obtain hyperbolic node representations of different views, which includes:
mapping the node features from an Euclidean space to a hyperbolic Lorentz model by exponential mapping:

$$\begin{matrix}{x}^{ℒ} = {exp}_{o} ( [ 0 , {x}^{E} ] ) \\ = [ cosh ( {‖ {x}^{E} ‖}_{2} ) , sinh ( {‖ {x}^{E} ‖}_{2} ) \frac{{X}^{E}}{{‖ {x}^{E} ‖}_{2}} ]\end{matrix}$$

where [symbol] indicates the Lorentz model, E indicates the Euclidean space, x^{E}∈ [symbol] ^{n×d} is an Euclidean feature of a node, and x [symbol] ∈ [symbol] ^{n×(d+1)} is a hyperbolic feature of a node;
inputting the node features into a hyperbolic-hyperbolic linear transformation layer, mapping the node features from a hyperbola to a hyperbola by using an orthogonal submatrix as a learnable parameter for linear transformation, and extracting the node features:

$${\overline{h}}_{i}^{l , ℒ} = {Wh}_{i}^{l - 1 , ℒ} s . t . W = [ \begin{matrix}1 & 0 \\ 0 & \hat{W}\end{matrix} ] , {\hat{W}}^{T} \hat{W} = I$$

where W is a learnable transformation matrix, Ŵ is an orthogonal submatrix, I is an identity matrix, and h̅ᵢ^{l,} [symbol] is a hyperbolic embedding representation of node i in layer l;
linearly aggregating node neighbors through different structural information under the three constructed views, calculating a hyperbolic mean on the node embedding representations under a Klein model by an Einstein midpoint method defined under the Klein model in the hyperbolic space, which includes projecting the hyperbolic node embedding representations under the Lorentz model to the Klein model according to a specific formulas as follows:

$${\overline{h}}_{i}^{l , 𝒦} = {p}_{ℒ \to 𝒦} ( {\overline{h}}_{i}^{l , ℒ} ) \\ {m}_{i}^{l , 𝒦} = {\sum }_{j ∈ N ( i )} {γ}_{j} {\overline{h}}_{j}^{l , 𝒦} / {\sum }_{j ∈ N ( i )} {γ}_{j} \\ {h}_{i}^{l , 𝒦} = {p}_{𝒦 \to ℒ} ( {m}_{i}^{l , 𝒦} )$$

where [symbol] is the Klein model, [symbol] [symbol] _{→} [symbol] and [symbol] [symbol] _{→} [symbol] are identical transformations between the Lorentz model and the Klein model, and hᵢ^{l,} [symbol] is hyperbolic embedding of node i under the Lorentz model after neighbor aggregation; and
projecting the hyperbolic embedding after neighbor aggregation to a Poincare model, activating the node embedding representations through manifold-preserving activation under the Poincare model, and then projecting the node embedding representations back to the Lorentz model according to a formula as follows:

$${h}_{i}^{l , ℒ} = {p}_{𝒫 \to ℒ} ( σ ( {p}_{ℒ \to 𝒫} ( {h}_{i}^{l , ℒ} ) ) )$$

where [symbol] [symbol] _{→} [symbol] and [symbol] [symbol] _{→} [symbol] are identical transformations between the Lorentz model and the Poincare model; and
performing a pooling operation on the hyperbolic node embedding of each view to obtain a hyperbolic graph embedding of each view:

$${p}^{k , ℒ} = \sqrt{{\sum }_{i = 1}^{N} {{w}_{i} ( {h}_{i}^{k , ℒ} )}^{2}}$$

where [symbol] ^{k,} [symbol] is a graph embedding representation of view k,

$${w}_{i} = \frac{{d}_{i}}{{\sum }_{i = 1}^{N} {d}_{i}}$$

is an importance score of a node, dᵢ is a degree of node i, and hᵢ^{k,} [symbol] is a node representation of node i on view k;
step 3, obtaining attention scores of views by a hyperbolic-hyperbolic attention fusion module;
concatenating hyperbolic graph embedding of each view to calculate an attention score of each view:

$$p = cat ( {p}^{1 , ℒ} , … , {p}^{v , ℒ} )$$

where cat indicates a concatenating operation, v indicates a view number, and [symbol] ^{v,} [symbol] indicates a hyperbolic graph representation of the view v;
remapping the concatenated representation back to the hyperbolic space by exponential mapping, obtaining an attention weight of each view representation by a multilayer perceptron (MLP) layer, where the MLP layer includes two linear layers and activation layers, and obtaining an attention weight by a softmax layer according to a formula as follows:

$$s = softmax ( σ ( {f}_{2} ( σ ( {f}_{1} ( {exp}_{o} ( p ) ) ) ) ) )$$

where s indicates an attention score vector obtained by the MLP layer of the Lorentz model, and f₁ and f₂ indicate the two linear layers; and
step 4, obtaining a node embedding representation on the basis of multiple views by a hyperbolic-hyperbolic weighted representation; and weighting and summing, by an embedding fusion layer, hyperbolic node embedding of each view to obtain a unified hyperbolic node embedding based on the view importance scores obtained by the view attention layer, where a formula of the embedding fusion layer is as follows:

$${c}_{j}^{ℒ} = \sqrt{{\sum }_{k = 1}^{v} {{s}_{k} ( {h}_{j}^{k , ℒ} )}^{2}}$$

where sₖ is the attention score of view k, hⱼ^{k,} [symbol] is the hyperbolic node embedding of view k on a j^{th} dimension, and cⱼ [symbol] is the hyperbolic node embedding after attention weighting on a j^{th} dimension.

Compared with the prior art, the present disclosure has the beneficial effects:

The method provided in the present disclosure is a multi-view hyperbolic-hyperbolic graph representation learning method. In the present disclosure, multi-view learning is provided, such that the node representations are more accurate, and the problem of representation capability limitation caused by information difference between a single-view network and a target adjacency matrix is solved. Moreover, with geometric characteristics of hyperbolic geometry, low distortion embedding of the node is achieved under the condition that all graph operations are carried out in the hyperbolic space, and the deviation caused by the existing hyperbolic model operation depending on tangent space is solved. The present disclosure is also widely applied to downstream tasks, is suitable for various network structures and scenes, can be applied to link prediction tasks of a community network, a citation network, a recommendation network, etc., and can also be applied to node classification and graph classification tasks of a protein structure graph, a molecular graph, etc., such that data analysis and information mining are carried out, and the present disclosure has great significance for graph machine learning and actual business.

### BRIEF DESCRIPTION OF THE DRAWINGS

FIG. 1 is a flowchart of a multi-view hyperbolic-hyperbolic graph representation learning method; and

FIG. 2 is an architecture diagram of the multi-view hyperbolic-hyperbolic graph representation learning method.

### DETAILED DESCRIPTION OF THE EMBODIMENTS

A multi-view hyperbolic-hyperbolic graph representation learning method of the present disclosure will be further described in detail below with reference to the accompanying drawings.

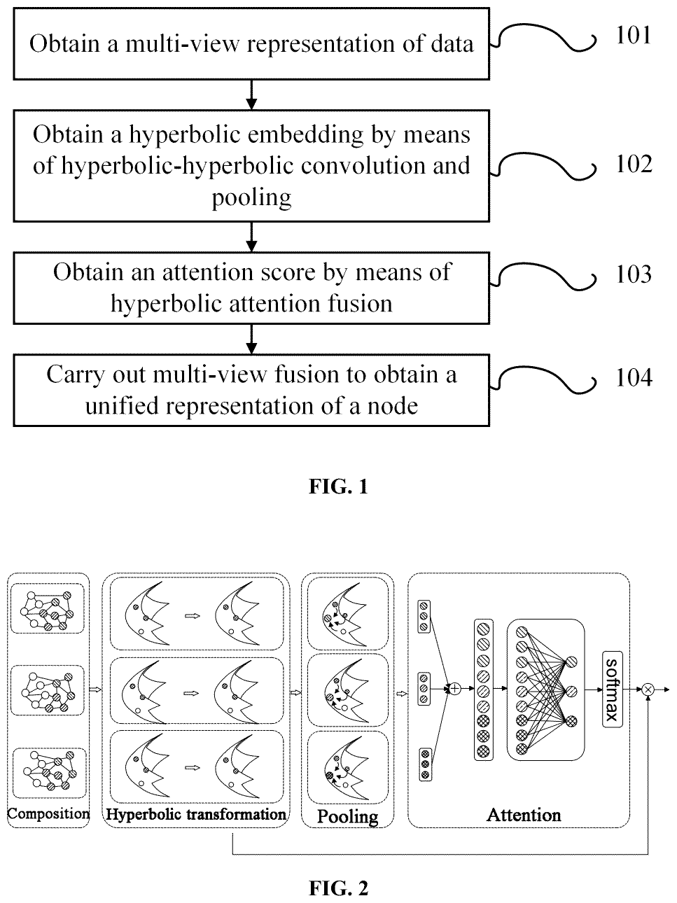

As shown in FIG. 1, a method provided by the present disclosure is a multi-view hyperbolic-hyperbolic graph representation learning method, and includes a multi-view construction module, a hyperbolic-hyperbolic graph convolution module, and a hyperbolic-hyperbolic attention fusion module.

The multi-view hyperbolic-hyperbolic graph representation learning method specifically includes as follows.

A multi-view construction module (step 101): graph data can include topological information and node feature information in a graph, and compared with an ideal structure of an underlying network, there can be some deviation. By means of multiple topological structures with different perspectives, the deviation can be naturally reduced, and more accurate node representations can be learned. Therefore, on the basis of an adjacency matrix, views are constructed based on a topological structure and node features respectively. For the topological structure, a diffusion matrix is constructed by using an adjacency matrix-based diffusion method, so as to reflect a global structure of a network. For the node features, a probability of a connecting edge of two nodes on their feature similarity is measured by using a cosine similarity method, and a connecting edge is constructed for two nodes based on a certain threshold.

A node feature mapping module (step 102): for graph structure data with a scale-free property, representation capability of Euclidean space is extremely limited. High distortion is produced when the graph is embedded. However, representation capability of hyperbolic geometric space increases exponentially with a radius, and the hyperbolic geometric space is extremely suitable for embedding of such a network. Therefore, a hyperbolic graph convolution network is used to model the graph data. According to properties of hyperbolic geometry, the node features are mapped to the hyperbolic space through exponential mapping. A Lorentz model in hyperbolic models is used:

$${x}^{ℒ} = {exp}_{o} ( [ 0 , {x}^{E} ] ) = [ cosh ( {‖ {x}^{E} ‖}_{2} ) , sinh ( {‖ {x}^{E} ‖}_{2} ) \frac{{x}^{E}}{{‖ {x}^{E} ‖}_{2}} ]$$

where x^{E}∈ [symbol] ^{n×d} is an Euclidean feature of the node, and x [symbol] ∈ [symbol] ^{n×(d+1)} is a hyperbolic feature of the node.

A hyperbolic-hyperbolic graph convolution module (step 103): an existing hyperbolic graph operation is often performed in a tangent space, and the tangent space is only a local approximation of the hyperbolic space. In order to minimize the deviation of graph information in a propagation process of a neural network, the node representation is always embedded in the hyperbolic model, and the hyperbolic-hyperbolic graph convolution module is defined. The module is mainly divided into three parts:
1) a hyperbolic-hyperbolic linear layer: the node features mapped to the hyperbolic space are input into the hyperbolic-hyperbolic graph convolution module. In order for node embedding after linear transformation to remain in a Lorentz model, inner product requirements of Lorentz need to be satisfied:

$${〈 u , u 〉}_{ℒ} := - {u}_{0} {u}_{0} + {u}_{1} {u}_{1} + {⋯u}_{d} {u}_{d} = 0 ,$$

and a submatrix with orthogonality is used as a linear transformation matrix:

$${\overline{h}}_{i}^{l , ℒ} = {Wh}_{i}^{l - 1 , ℒ} s . t . W = [ \begin{matrix}1 & 0 \\ 0 & \hat{W}\end{matrix} ] , {\hat{W}}^{T} \hat{W} = I$$

where W is a learnable transformation matrix, Ŵ is an orthogonal submatrix, I is an identity matrix, and h̅ᵢ^{l,} [symbol] is a hyperbolic representation of node i in layer l;
2) a hyperbolic neighbor aggregation layer: neighbor information of nodes is aggregated under each view. An Einstein midpoint method under a Klein model in the hyperbolic space is used as a method for aggregating neighbor information. The hyperbolic node embedding under the Lorentz model after linear transformation is mapped to the Klein model through identical mapping between models, and an Einstein midpoint is calculated as the hyperbolic node embedding after aggregation, which is mapped back to the Klein model through identical mapping according to specific calculation formulas as follows:

$${\overline{h}}_{i}^{l , 𝒦} = {p}_{ℒ \to 𝒦} ( {\overline{h}}_{i}^{l , ℒ} ) \\ {m}_{i}^{l , 𝒦} = {\sum }_{j ∈ N ( i )} {γ}_{j} {\overline{h}}_{j}^{l , 𝒦} / {\sum }_{j ∈ N ( i )} {γ}_{j} \\ {h}_{i}^{l , 𝒦} = {p}_{𝒦 \to ℒ} ( {m}_{i}^{l , 𝒦} )$$

where [symbol] is the Klein model, p [symbol] _{→} [symbol] and p [symbol] _{→} [symbol] are identical mapping between the Lorentz model and the Klein model, and hᵢ^{l,} [symbol] is a hyperbolic embedding of node i under the Lorentz model after neighbor aggregation; and
3) a hyperbolic activation layer: a common nonlinear activation function applied to the Lorentz model can break a manifold constraint, and the nonlinear activation function applied to the Poincare model is manifold-preserving. The nonlinear activation function applied to the Poincare model is used. The node embedding under the Lorentz model after neighbor aggregation is mapped to the Poincare model through identical mapping to apply the nonlinear activation, and then the node embedding is mapped back to the Lorentz model through identical mapping. The specific calculation formula is as follows:

$${h}_{i}^{l , ℒ} = {p}_{𝒫 \to ℒ} ( σ ( {p}_{ℒ \to 𝒫} ( {h}_{i}^{l , ℒ} ) ) )$$

where [symbol] [symbol] _{→} [symbol] and [symbol] [symbol] _{→} [symbol] are identical transformations between the Lorentz model and the Poincare model, and σ is an activation function Relu.

A hyperbolic attention fusion module: three views and node features are input into the hyperbolic-hyperbolic graph convolution layer, so as to obtain the hyperbolic node embeddings of different views. In order to better fuse consistency information in different views, the hyperbolic attention fusion module is defined. The module is mainly divided into four parts:
1) the hyperbolic node embedding of each view is input into a hyperbolic-hyperbolic pooling layer to obtain a hyperbolic graph embedding [symbol] ^{k,} [symbol] of each view. Pooling operation is performed by using the following formula:

$${p}^{k , ℒ} = \sqrt{{\sum }_{i = 1}^{N} {{w}_{i} ( {h}_{i}^{k , ℒ} )}^{2}}$$

where [symbol] ⱼ^{k,} [symbol] is a graph embedding representation of view k on the j^{th} dimension, wᵢ=dᵢ/Σᵢ₌₁^{N} dᵢ is a node importance score, dᵢ is a degree of node i, and h_{i,j}^{k,} [symbol] is a node representation of node i on view k on the j^{th} dimension.
2) The hyperbolic graph embeddings for the views are concatenated by using the following formula:

$$p = cat ( {p}^{1 , ℒ} , … , {p}^{v , ℒ} )$$

where cat indicates a concatenating operation, v indicates a view number, and [symbol] ^{v,} [symbol] indicates the hyperbolic graph representation on view v.
3) The concatenating representation is mapped back to the hyperbolic space through exponential mapping and is input into the Lorentz MLP (multi-layer perceptron) module, the MLP module includes two linear layers and a sigmoid activation layer. The number of neurons in a last layer must match the number of views. Finally, the concatenating representation is added to a softmax layer to obtain the view attention score. A specific formula is as follows:

$${c}_{j}^{ℒ} = \sqrt{{\sum }_{k = 1}^{v} {{s}_{k} ( {h}_{j}^{k , ℒ} )}^{2}}$$

where s indicates an attention score vector obtained through the Lorentz MLP layer, and f₁ and f₂ indicate two linear layers and an activation layer.
4) A fused hyperbolic node embedding representation can be obtained through the attention scores of the multiple views, and information obtained in different views is fused through the attention scores. The idea of embedding fusion layer is consistent with that of graph pooling. A formula of the embedding fusion layer is as follows:

$$s = softmax ( σ ( {f}_{2} ( σ ( {f}_{1} ( {exp}_{o} ( p ) ) ) ) ) )$$

where sₖ is the attention score of view k, hⱼ^{k,} [symbol] is the hyperbolic node embedding of view k, and cⱼ [symbol] is a hyperbolic node embedding representation after attention weighting on the j^{th} dimension.

What is claimed is:

1. multi-view hyperbolic-hyperbolic graph representation learning method, comprising:
constructing two views from a network topology and node features, mapping the node features from an Euclidean space to a hyperbolic space, and inputting hyperbolic node embedding representations and three views into a hyperbolic-hyperbolic graph convolution module respectively, wherein the hyperbolic-hyperbolic graph convolution module comprises a linear transformation layer, a neighbor aggregation layer and an activation layer; and
mapping, by a hyperbolic attention fusion module, hyperbolic node embedding representations of the three views into unified hyperbolic node embedding for a downstream task,
wherein the hyperbolic attention fusion module comprises a view attention layer and an embedding fusion layer.

2. The method according to claim 1, wherein constructing the two views from the network topology and the node features comprises:
constructing the views by a closed-form solution of a personal pagerank method, from a topology structure of a graph, with a following formula:
$${S}^{PPR} = α ( {I}_{n} - ( 1 - α ) {D}^{- \frac{1}{2}} {AD}^{- \frac{1}{2}} )$$
wherein D is a degree matrix of the graph, A is an adjacency matrix of the graph, a is a parameter, and Iₙ is a n-order identity matrix; and
calculating a similarity between nodes from the node features based on a cosine similarity, and constructing an edge between two nodes with similarity greater than a threshold delta according to a formula as follows:
$$s = Similarity ( {x}_{i} , {x}_{j} ) = \frac{{x}_{i} \cdot {x}_{j}}{‖ {x}_{i} ‖ ‖ {x}_{j} ‖}$$
wherein xᵢ and xⱼ are eigenvectors of node i and node j respectively.

3. The method according to claim 1, wherein mapping the node features from the Euclidean space to the hyperbolic space before inputting the views and the node features into the hyperbolic-hyperbolic convolution layer comprises:
mapping the node features to a Lorentz model by exponential mapping according to a formula as follows:
$${x}^{ℒ} = {exp}_{o} ( [ 0 , {x}^{E} ] ) = [ cosh ( {‖ {x}^{E} ‖}_{2} ) , sinh ( {‖ {x}^{E} ‖}_{2} ) \frac{{x}^{E}}{{‖ {x}^{E} ‖}_{2}} ]$$
wherein x^{E}∈ [symbol] ^{n×d} is an Euclidean feature of a node, and x [symbol] ∈ [symbol] ^{n×(d+1)} is a hyperbolic feature of a node.

4. The method according to claim 1, wherein the hyperbolic-hyperbolic graph convolution module is configured for aggregating neighbor information of nodes, and comprises a hyperbolic-hyperbolic linear transformation layer, a neighbor aggregation layer and an activation layer, wherein
the hyperbolic node embedding after linear transformation is preserved in the hyperbolic space by the hyperbolic-hyperbolic linear transformation layer;
the neighbor information of the nodes is aggregated to a central node by the hyperbolic neighbor aggregation layer; and
aggregated hyperbolic node embedding is non-linearly mapped by the hyperbolic activation layer to improve a network expression capability.

5. The method according to claim 1, wherein the hyperbolic attention fusion module comprises a view attention layer and an embedding fusion layer, wherein
hyperbolic node embedding of each view is input into a pooling layer by the view attention layer to obtain a hyperbolic graph embedding of each view, and the hyperbolic graph embeddings of views are concatenated, the concatenated hyperbolic graph embedding is mapped to the hyperbolic space via exponential mapping and input into a multilayer perceptron (MLP) layer, so as to obtain an attention score of each view; and
hyperbolic node embeddings of the three views are weighted and fused into a unified hyperbolic node representation by the embedding fusion layer based on the attention score of each view.

6. The method according to claim 4, wherein the hyperbolic-hyperbolic linear transformation layer is configured for:
extracting features of the hyperbolic node embeddings, wherein in order to ensure that the extracted node embedding is still on a hyperbola, a definition of a Lorentz model is satisfied:
$${〈 u , u 〉}_{ℒ} := - {u}_{0} {u}_{o} + {u}_{1} {u}_{1} + ⋯ + {u}_{d} {u}_{d} = 0 ,$$
such that a formula of the hyperbolic-hyperbolic linear transformation layer is:
$${\overline{h}}_{i}^{l , ℒ} = {Wh}_{i}^{l - 1 , ℒ} s . t . W = [ \begin{matrix}1 & 0 \\ 0 & \hat{W}\end{matrix} ] , {\hat{W}}^{T} \hat{W} = I$$
wherein W is a learnable transformation matrix, Ŵ is an orthogonal submatrix, I is an identity matrix, and h̅ᵢ^{l,} [symbol] is a hyperbolic representation of node i in layer l.

7. The method according to claim 4, wherein the hyperbolic neighbor aggregation layer is configured for:
for the hyperbolic node embedding after the linear transformation, calculating a hyperbolic mean by an Einstein midpoint method defined in the hyperbolic space, wherein the hyperbolic node embedding under a Lorentz model is projected to a Klein model to perform the hyperbolic mean by the Einstein midpoint method, and then the hyperbolic node embedding is projected back to the Lorentz model according to formulas as follows:
$${\overline{h}}_{i}^{l , 𝒦} = {p}_{ℒ \to 𝒦} ( {\overline{h}}_{i}^{l , ℒ} ) \\ {m}_{i}^{l , 𝒦} = {\sum }_{j ∈ N ( i )} {γ}_{j} {\overline{h}}_{j}^{l , 𝒦} / {\sum }_{j ∈ N ( i )} {γ}_{j} \\ {h}_{i}^{l , ℒ} = {p}_{𝒦 \to ℒ} ( {m}_{i}^{l , 𝒦} )$$
wherein [symbol] is the Klein model, [symbol] [symbol] _{→} [symbol] and [symbol] [symbol] _{→} [symbol] are identical transformations between the Lorentz model and the Klein model, and hᵢ^{l,} [symbol] is a hyperbolic embedding of node i after neighbor aggregation under the Lorentz model. 8 The method according to claim 4, wherein the hyperbolic activation layer is configured for:
projecting the hyperbolic embedding after the hyperbolic neighbor aggregation to a Poincare model, and projecting a node embedding after manifold-preserving activation under a Poincare model back to the Lorentz model according to a formula as follows:
$${h}_{i}^{l , ℒ} = {p}_{𝒫 \to ℒ} ( σ ( {p}_{ℒ \to 𝒫} ( {h}_{i}^{l , ℒ} ) ) )$$
wherein [symbol] [symbol] _{→} [symbol] and p [symbol] _{→} [symbol] are identical transformations between the Lorentz model and the Poincare model, and σ is an activation function Relu.

9. The method according to claim 5, wherein the view attention layer is configured for:
performing hyperbolic-hyperbolic pooling on the node embedding representations of the views to obtain a hyperbolic graph embedding representation of each view, wherein a formula of the pooling is as follows:
$${p}^{k , ℒ} = \sqrt{{\sum }_{i = 1}^{N} {{w}_{i} ( {h}_{i}^{k , ℒ} )}^{2}}$$
wherein [symbol] ^{k,} [symbol] is a graph embedding representation of view k,
$${w}_{i} = \frac{{d}_{i}}{{\sum }_{i = 1}^{N} {d}_{i}}$$
is an importance score of the node, dᵢ is a degree of node i, and hᵢ^{k,} [symbol] is a node representation of node i on view k;
concatenating the hyperbolic graph embedding representations according to a concatenating formula as follows:
$$p = cat ( {p}^{1 , ℒ} , … , {p}^{v , ℒ} )$$
wherein cat indicates a concatenating operation, v indicates a view number, and [symbol] ^{v,} [symbol] indicates a hyperbolic graph representation of view v; and
remapping the concatenated representation back to the hyperbolic space by exponential mapping, and obtaining an attention score of the view by an MLP layer of the Lorentz model according to a formula as follows:
$$s = softmax ( σ ( {f}_{2} ( σ ( {f}_{1} ( {exp}_{o} ( p ) ) ) ) ) )$$
wherein s indicates an attention score vector obtained by the MLP layer, and f₁ and f₂ indicate two linear layers and an activation layer.

10. The method according to claim 5, wherein the embedding fusion layer is configured for:
weighting and summing the hyperbolic node embedding representations of the views based on the attention scores of the views to obtain a fused hyperbolic node embedding representation, wherein a formula of the embedding fusion layer is as follows:
$${c}_{j}^{ℒ} = \sqrt{{\sum }_{k = 1}^{v} {{s}_{k} ( {h}_{j}^{k , ℒ} )}^{2}}$$
wherein sₖ is an attention score of view k, h^{k,} [symbol] is a hyperbolic node embedding representation of view k, and cⱼ [symbol] is a hyperbolic node embedding representation after attention weighting on a j^{th} dimension.
